(19) United States
(12) Patent Application Publication
(10) Pub. No.: US 2013/0315029 A1
(43) Pub. Date: Nov. 28, 2013

(54) Device and Method For Metering And/Or Feeding In Liquid Colorants And/Or Functional Additives

(71) Applicants: Rowasol GmbH, Pinneberg (DE); Oerlikon Textile GmbH & Co. KG, Remscheid (DE)

(72) Inventors: Ulrich Helbing, Burscheid (DE); Dietrich Witzler, Rommerskirchen (DE); Uwe Wende, Waltrop (DE); Klaus Stefan Meier, Hamburg (DE)

(73) Assignees: Rowasol GmbH, Pinneberg (DE); Oerlikon Textile GmbH & Co. KG, Remscheid (DE)

(21) Appl. No.: 13/949,469

(22) Filed: Jul. 24, 2013

Related U.S. Application Data
(63) Continuation-in-part of application No. PCT/EP2012/050460, filed on Jan. 12, 2012.

(30) Foreign Application Priority Data
Jan. 26, 2011 (DE) 10 2011 009 426.1

(51) Int. Cl. B01F 15/02

(52) U.S. Cl. CPC B01F 15/0216
USPC 366/152.2

(57) ABSTRACT

A device and method for metering and/or feeding in liquid colorants and/or functional additives, in particular odorants is described. The device includes a plurality of tanks, a plurality of primary pumps each of which are associated with respective tanks and a colorant mixing device. The colorant mixing device has a plurality of valves with valve inlets and valve outlets, a collecting chamber in a collecting block which is connected to the valve outlets via very small volumes on its inlet side. A mixer is connected to the collecting chamber and a dispensing line is connected to the mixer. The primary pumps are connected in each case to a valve inlet. The through flow volume of the very small volumes is in each case at most 10 cm³, preferably considerably smaller. A further pump for feeding in liquid colorants or additives into a polymer melt can be dispensed with.

This application is a continuation-in-part of and claims the benefit of priority from PCT application PCT/EP2012/050460 filed 12 Jan. 2012; and German Patent Application 10 2011 009 426.1 filed 26 Jan. 2011, the disclosure of each is hereby incorporated by reference in its entirety.

### BACKGROUND

The present invention relates to a device and a method for metering and/or feeding in liquid colorants and/or functional additives, with a plurality of tanks and primary pumps associated with tanks.

Devices for metering and feeding in liquid colorants into a polymer melt are known from the prior art. As a rule, these devices include a plurality of tanks in which the colorants are available. One or several primary pumps for conveying the colorants are associated with the tanks. The colorants conveyed from the at least one primary pump are passed from a secondary pump via a feed line into a polymer melt.

WO 2009/037118 describes an arrangement for metering and feeding in liquid colorants in which the liquid colorants are conveyed from the tanks by means of a metering pump. The metering of the liquid colorants takes place via a distribution valve arranged between the tanks and the metering pump. In this arrangement, a feed pump is additionally provided, and is arranged downstream from the metering pump and feeds the colorants conveyed from the metering pump to a polymer melt with suitable pressure.

The colorants available in the tanks are conveyed by a metering pump, wherein each metering pump has a distribution valve arranged upstream. The colorants are consolidated in a distributor block so that the consolidated colorants are fed from a feed pump to a mixer, in which the colorants are homogeneously mixed and from which the mixed colorants are fed to a pickup system. In this and other known devices and methods, it is always necessary to use a primary pump for metering the colorants and a secondary pump to feed in the mixed colors to a pickup system.

As a result, after a tank change with replacement of colorants or in the case of a change of formula in which some of the colorants previously used are no longer required, the colorant remnants in the lines disturb the subsequent colorant composition. The phrase “colorant composition” refers to the precise composition of the colorant mixture arising from the mixed liquid colorants. The same problem also ensues in the case of fluid functional additives, e.g. odorants, in the event of a change in composition.

### SUMMARY

Therefore the invention addresses the problem or at least partially mitigates the problems described with respect to the prior art. In particular, a device according to the present invention has a structure that is designed with fewer components and in the case of a change of composition, it takes place without colorant carryovers or carryovers of the functional additive.

In particular, the problems are solved by a device for metering and/or feeding in liquids, in particular liquid colorants comprising a plurality of tanks, a plurality of primary pumps associated with the tanks and a colorant mixing device. The colorant mixing device includes a plurality of valves with valve inlets and valve outlets, a collecting chamber in a collecting block, said chamber being connected to the valve outlets via very small volumes on its inlet side, a mixer which is connected to the collecting chamber and a dispensing line connected to the mixer, wherein the primary pumps are connected in each case to a valve inlet. In principle, the inventive device is also suitable for metered supply of other liquid substances to a pickup system. In the process, liquids of all types of fluid substances, in particular colorants and/or other functional additives, such as odorants are included. In one particular embodiment, a mixture of liquid colorant and at least one functional additive is fed with the device.

In one embodiment, the primary pumps are directly connected to the valve inlets. By this, it is meant that there is only one line between the primary pumps and the valve inlets and hence in particular there is no further pump for supplying the colorants or additives.

The tanks can hold different liquid colorants, functional additives or a rinse solution for rinsing the device. Each of the held liquids is supplied by a primary pump. It is preferred that the primary pumps are integrated in the tanks so that in the event of a change of tanks the primary pumps are also replaced. Each primary pump integrated in a tank is connected to the colorant mixing device via a valve inlet of the valves, preferably being detachably connected so that the tanks with the primary pumps can be joined to the colorant mixing device.

In the colorant mixing device a collecting block with a collecting chamber is arranged downstream of the valves, wherein the valve outlets are connected to the collecting chamber via very small volumes. These can be very short lines preferably however, arrangements without lines with very small volumes between shutoff devices of the valves and the collecting chamber. Hence, in operation the liquid colorants reach the common collecting chamber via the very small volumes in the case of an opened valve and in the case of a feeding primary pump. The colorants in the collecting chamber reach a mixer where they are homogeneously blended. The collecting block is thus a unit in which the collecting chamber is arranged, wherein the individual colorants are fed to the collecting block and from which the at least partially mixed colorants are discharged. In one preferred embodiment, the mixer is arranged in the collecting block. The colorants are fed from the mixer to a dispensing line. Via a connection sealing the dispensing line, the mixed colorants are fed to a pickup system, preferably a polymer melt.

An important part of the invention is that the colorant mixing device is also on its own, that is, separate from the tanks and the primary pumps and can be used to solve the problem associated with the prior art devices and methods.

In accordance with the invention, the mixed colorant is supplied only from the primary pumps. An additional pump for feeding into a pickup system is not necessary. Through the use of very small volumes between the valve outlets and the collecting chamber, the quantity of colorant, which is in the line between the closed valve outlet and the collecting chamber is minimized in the event of a change of the tank or in the event of a changed colorant composition, in particular in the case of a closed valve. As a result, the influence of a subsequent colorant composition by colorant located in these areas is prevented. In particular, due to the direct arrangement of the valve outlets on the collecting chamber, areas in which in the case of some operational states liquid is unintentionally deposited are dispensed with altogether.

Through the use of valves, liquid is prevented from unintentionally traveling from the collecting chamber and/or the very small volumes into the lines connecting the primary pumps and the valve inlets. Hence, another cause for unintentional changing of the colorant composition is eliminated.

In accordance with an advantageous improvement of the invention, the small volumes exhibit a throughflow volume of a maximum of 60 cm³ (cubic centimeters), preferably a maximum of 10 cm³, especially preferably a maximum of 1 cm³. Very especially preferably, the small volumes are nearly zero. In this case, the shutoff devices limit the collecting chamber, which one can achieve for example by valves screwed into the collecting block. By sealing valve outlets that are not being used and that are in very close proximity to the collecting chamber, the quantity of the colorant unintentionally getting into the colorant composition can be kept low.

According to an especially preferred embodiment, the valves are connected in series bordering on the collecting block. According to an alternative preferred embodiment, the valves are connected in a star pattern on the collecting block.

In accordance with a further advantageous embodiment of the invention, the valve outlets are arranged in the collecting block. In this case, the valves are preferably formed by screw-in valves, which are screwed into corresponding boreholes in the collecting block. The very small volumes hence constitute the throughflow volume of the boreholes between the valve outlet and the collecting chamber, said valve outlet and collecting chamber being able to merge directly into one another. The volume of the very small volumes can hence be reduced to nearly zero. In this case, the very small volume can be rinsed through the colorant streaming through the collecting chamber and a colorant residue in the very small volume very quickly gets into the colorant mixture, as a result of which the colorant carryover is quite limited in duration. In the case of a rinse cycle, the colorant residue will be eliminated by a rinsing liquid.

The presence of a pressure sensor in the dispensing line for measurement of the pressure in the dispensing line is advantageous for monitoring the operating conditions.

In order to make possible a cleansing of the colorant mixing device, it is preferred that a rinsing valve is arranged in the dispensing line. A rinsing liquid held in one of the tanks can hence be used to rinse the valve, the very small volumes, the collecting chamber, the mixer and the dispensing line, wherein the rinsing liquid can be supplied to a rinsing container.

The mixer is preferably designed as a dynamic mixer with a separate drive, although as an alternative, the mixer can be designed as a static mixer.

In accordance with a preferred embodiment of the invention, the valves are electrically and/or pneumatically controlled. Hence, it is possible to actively influence the state of the valves. The valves are preferably operated either in a fully opened position or in a closed position. The metering of the colorant quantities fed to the collecting chamber therefore occurs only by the pump delivery rates provided by the primary pumps.

As an alternative, it is proposed that the valves are passively designed. This means that the valves function in the manner of a back pressure valve and are completely closed in the event of exceeding a predefined pressure, for example in the case of the operation of the primary pump are completely opened and in the event of the falling below predefined pressure, for example in the case of a switched off primary pump.

In an alternative embodiment of the inventive device, a secondary pump for feeding in the liquids to a downstream pickup system is arranged in the dispensing line. This secondary pump is able to feed in the mixed liquids with up to 300 bars of pressure.

In the case of another embodiment of the invention, the device comprises a controller, wherein the controller is connected to at least one of the following elements at least one valve, at least one primary pump, a pressure sensor, a mixer, or a rinsing valve.

The controller can therefore monitor and/or control all essential elements of the device. For example, the pressure in the dispensing line can be recorded and on the basis of the recorded pressure the pump delivery rates can be readjusted, wherein for adherence to a colorant composition the individual pump delivery rates always have the same proportion of the total pump delivery rate.

It is especially preferable that the inventive device is connected via the mixer to a polymer melt conducting device, in particular, an extruder or a melt line.

According to another aspect of the invention, a method for metering liquid colorants and feeding in the liquid colorants and/or functional additives to a polymer melt is proposed, wherein the liquid colorants are, in each case, fed to a mixer by means of a primary pump, mixed in the mixer and subsequently fed to the polymer melt at a pressure of not more than 20 bars, preferably not more than 10 bars, more preferably not more than 5 bars.

The inventive method in particular provides for the operation of the inventive device. With the inventive method, it is possible to feed a colorant mixture to a polymer melt with primary pumps conveying only the liquid colorants without additional feed pumps being necessary for feeding in the colorant mixture. Therefore, the liquid substances are preferably only conveyed by means of the primary pumps.

Preferably, the primary pumps can be operated separately from one another with different pump delivery rates, as a result of which the setting of predefined colorant compositions is possible. The ratio of the different pump delivery rates is kept constant during the entire feeding in of a colorant composition.

The details and advantages disclosed for the inventive device can be transferred and applied to the inventive method and vice versa.

### BRIEF DESCRIPTION OF THE DRAWINGS

The invention as well as the technical environment will be described with the help of the figures. We would like to point out the fact that while the figures show especially preferred embodiments of the invention, the invention is not restricted to these embodiments. The figures schematically show the following.

FIG. 1 shows an embodiment of the inventive device.

FIG. 2 shows a further embodiment of a mixing device of an inventive device.

### DETAILED DESCRIPTION

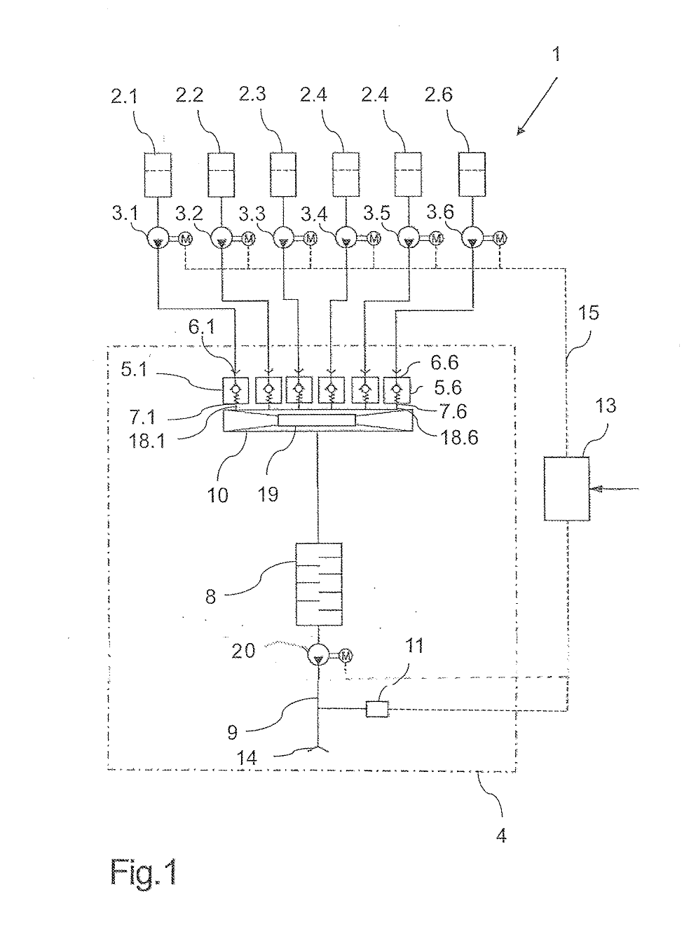

FIG. 1 schematically represents the structure of a first exemplary embodiment of the inventive device 1. The device 1 includes six tanks 2.1, 2.2, 2.3, 2.4, 2.5, and 2.6, in which different liquid colorants or a detergent are held. The tanks 2.1, 2.2, 2.3, 2.4, 2.5, and 2.6 are constructed pressure-proof and are each flow connected to a primary pump 3.1, 3.2, 3.3, 3..4, 3.5, and 3.6, respectively.

The device 1 further comprises a colorant mixing device 4, which includes six valves 5.1, 5.2, 5.3, 5.4, 5.5, and 5.6 with respective valve inlets 6.1, 6.2, 6.3, 6.4, 6.5, and 6.6 and respective valve outlets 7.1, 7.2, 7.3, 7.4, 7.5, and 7.6 and a collecting block 10. The valves 5.1, 5.2, 5.3, 5.4, 5.5, and 5.6 are connected to the collecting block 10 via the respective valve outlets 7.1, 7.2, 7.3, 7.4, 7.5, and 7.6 by means of respective very small volumes 18.1, 18.2, 18.3, 18.4, 18.5, and 18.6. The collecting block 10 includes a collecting chamber 19 which is fluidly connected to a mixer 8, wherein the mixer 8 in this exemplary embodiment is a static mixer 8. A dispensing line 9 is fluidly connected to the mixer 8, includes a pressure sensor 11 and ends in a connection 14. The device 1 can be joined to a pick up system, in particular a polymer melt conducting device via the connection 14. The device 1 further comprises a controller 13 which is connected with data lines 15 to the primary pumps 3.1, 3.2, 3.3, 3.4, 3.5, and 3.6 and the pressure sensor 11.

The colorants held in the tanks 2.1, 2.2, 2.3, 2.4, 2.5, and 2.6 are conducted from the primary pumps 3.1, 3.2, 3.3, 3.4, 3.5, and 3.6 to the collecting chamber 19 of the collecting block 10. The valves 5.1, 5.2, 5.3, 5.4, 5.5, and 5.6 are connected in between, said valves being constructed as back pressure valves, so that the valves 5.1, 5.2, 5.3, 5.4, 5.5, and 5.6 are only opened in the case of activated primary pumps 3.1, 3.2, 3.3, 3.4, 3.5, and 3.6. In the case of switched off primary pumps 3.1, 3.2, 3.3, 3.4, 3.5, and 3.6, the valves 5.1, 5.2, 5.3, 5.4, 5.5, and 5.6 are closed, so that if necessary the tanks or the primary pumps 3.1, 3.2, 3.3, 3.4, 3.5, and 3.6 integrated in the tanks can be replaced or colorants held in the corresponding tanks 2.1, 2.2, 2.3, 2.4, 2.5, and 2.6 are not used for the current colorant composition. Hence, the valves 5.1, 5.2, 5.3, 5.4, 5.5, and 5.6 also prevent liquid colorants from returning to sections not being used.

As a result of the fact that the connection between the outlets 7.1, 7.2, 7.3, 7.4, 7.5, and 7.6 of the valves 5.1, 5.2, 5.3, 5.4, 5.5, and 5.6 only includes a very small throughflow volume, in the event of a change in the colorant composition only a small quantity of old colorant gets into the colorant chamber, said old colorant still being located in a very small volume not being used 18.1, 18.2, 18.3, 18.4, 18.5, and 18.6. The colorants and the resulting colorant mixture will only be driven by the primary pumps 3.1, 3.2, 3.3, 3.4, 3.5, and 3.6, wherein the colorant mixture consolidated in the collecting chamber 19 is guided to the mixer 8, as a result of which the colorant mixture is further homogeneously blended. The homogeneously blended colorant mixture proceeds via the dispensing line and the connection 14 to a pickup system, in particular a polymer melt for a melt spinning process.

The provided colorant composition can be monitored by monitoring the pressure in the dispensing line 19 with the pressure sensor 11, wherein in the event of a change in pressure all pumps in operation are operated in accordance with a predefined colorant mixture composition at a constant ratio to one another.

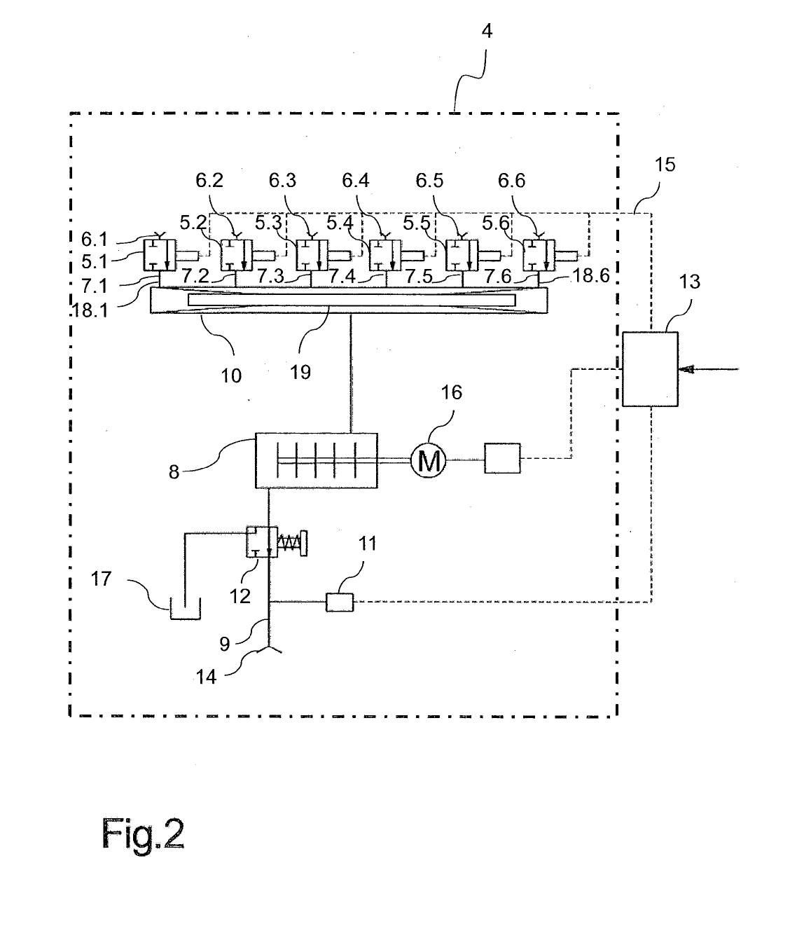

FIG. 2 schematically shows a further embodiment of a colorant mixing device 4 in accordance with an inventive device 1. The colorant mixing device 4 according to FIG. 2 differs only in a few elements in comparison to the embodiment according to FIG. 1. In the following, the differences of the two embodiments are explained. The colorant mixing device 4 comprises valves 5.1, 5.2, 5.3, 5.4, 5.5, and 5.6 with respective valve inlets 6.1, 6.2, 6.3, 6.4, 6.5, and 6.6 and respective valve outlets 7.1, 7.2, 7.3, 7.4, 7.5, and 7.6. The valves 5.1, 5.2, 5.3, 5.4, 5.5, and 5.6 are designed in this embodiment as pneumatically controlled valves with electric pilot control. A collecting block 10 with a collecting chamber 19 is arranged downstream of the valves 5.1, 5.2, 5.3, 5.4, 5.5, and 5.6, wherein the collecting chamber 19 is connected to a dynamic mixer 8, said dynamic mixer being driven by a motor 16. A rinsing valve 12 is arranged in the dispensing line arranged downstream of the mixer 8, said rinsing valve being able to divert the liquid flow from the mixer to a rinsing container. If the collecting chamber and the mixer 8 are rinsed with a rinsing liquid from one of the tanks 2.1, 2.2, 2.3, 2.4, 2.5, and 2.6, the dirty rinsing liquid is diverted to the rinsing container 17 so that the rinsing liquid does not get into the pickup system. Further, there is a pressure sensor 11 on the dispensing line 9.

In accordance with the present invention, a further pump for feeding in liquid colorants and/or fluid additives into a polymer melt can be dispensed with. In addition, the inventive device and method prevent colorants or additives from running back into unused connections or from accumulating in dead spaces, which could otherwise lead to colorant carryovers or additives in a colorant composition which is changed later.

### REFERENCE LIST

1 Device

2, 2.1, 2.2, . . . 2.6 Tank

3, 3.1, 3.2, . . . 3.6 Primary pump

4 Colorant mixing device

5, 5.1, 5.2, . . . 5.6 Valve

6,6.1, 6.2, . . . 6.6 Valve inlets

7,7.1, 7.2, . . . 7.6 Valve outlets

8 Mixer

9 Dispensing line

10 Collecting block

11 Pressure sensor

12 Rinsing valve

13 Controller

14 Connection

15 Data line

16 Motor

17 Rinsing container

18, 18.1, 18.2 . . . 18.6 Very small volumes

19 Collecting chamber

20 Secondary Pump

1. A device for metering and/or feeding in liquids, in particular fluid colorants and/or functional additives, comprising
a. a plurality of tanks;
b. a plurality of primary pumps, with each primary pump fluidly associated with a respective tank;
c. a colorant mixing device with a plurality of valves, each having a valve inlet and a valve outlet, wherein each valve is fluidly associated with a respective primary pump;
d. a collecting chamber in a collecting block that is fluidly connected to each valve outlet via very a small volume on an inlet side of the collecting block,
e. a mixer connected to the collecting chamber and;
f. a dispensing line exiting the mixer.

2. The device according to claim 1, wherein each very small volume includes a throughflow volume of a maximum of 10 cm³.

3. The device according to claim 1, wherein each very small volume includes a throughflow volume of a maximum of 1 cm³.

4. The device according to claim 1, wherein the valve outlets are located within the collecting block.

5. The device according to claim 1, further comprising a pressure sensor associated with the dispensing line for measuring the pressure in the dispensing line.

6. The device according to claim 1, further comprising a rinsing valve located in the dispensing line.

7. The device according to claim 1, wherein the mixer is one of a static mixer or a dynamic mixer.

8. The device according to claim 1, wherein the valves can be electrically controlled and/or pneumatically controlled.

9. The device according to claim 1, wherein the valves are passively designed.

10. The device according to claim 1, further comprising a secondary pump in fluid connection with the dispensing line for feeding in the liquids to a downstream pickup system.

11. The device according to claim 1, further comprising:
a. a pressure sensor associated with the dispensing line for measuring the pressure in the dispensing line;
b. a rinsing valve located in the dispensing line; and,
c. a secondary pump in fluid connection with the dispensing line for feeding in the liquids to a downstream pickup system.

12. The device according to claim 1, further comprising a controller connected to at least one of the valves, the primary pump, and the mixer.

13. The device according to claim 11, further comprising a controller connected to at least one of the valve, the primary pump, the pressure sensor, the mixer, the rinsing valve, and the secondary pump.

14. The device according to claim 1, wherein the mixer is connected to a polymer melt conducting device.

15. A method for metering a plurality of liquids and feeding the same to a polymer melt, comprising:
a. feeding the each of the plurality of liquids to a mixer with a primary pump associated with each of the plurality of liquids;
b. mixing each of the plurality of liquids in a mixer to form a mixture; and
c. subsequently, feeding the mixture to the polymer melt at a pressure of not more than 20 bars.

16. The method according to claim 15, wherein each of the primary pumps can be operated separately from one another with different pump delivery rates.

17. The method according to claim 15 wherein each liquid is conveyed only by means of the respective primary pump.
